(19) United States
(12) Patent Application Publication
(10) Pub. No.: US 2023/0406671 A1
(43) Pub. Date: Dec. 21, 2023

(54) METHOD FOR DETECTING CHANGES IN AN AREA TO BE MONITORED

(71) Applicant: Inventio AG, Hergiswil (CH)

(72) Inventors: Lars Dehmel, Berlin (DE); Felix Pfeifer, Berlin (DE)

(21) Appl. No.: 18/249,978

(22) PCT Filed: Oct. 28, 2021
(86) PCT No.: PCT/EP2021/079987

§ 371 Date: Apr. 21, 2023

(30) Foreign Application Priority Data
Oct. 29, 2020 (EP) 20204658.7

(51) Int. Cl. B66B 1/34; B66B 27/00; B66B 5/00; G01S 15/04; G01S 7/53

(52) U.S. Cl. CPC B66B 1/3476; B66B 27/00; B66B 5/0012; G01S 15/04; G01S 7/53; B66B 29/005

(57) ABSTRACT

A method for detecting changes in an area to be monitored of a conveying system utilizes a sound sensor and an evaluation unit connected to the sound sensor. The method includes emitting an acoustic pulse into the area to be monitored, recording an acoustic response signal of the pulse as an actual signal, determining an envelope of the actual signal, and detecting changes on the basis of the envelope.

### FIELD

The present invention relates to a method for detecting changes in an area to be monitored of a conveying system, to a method for detecting an empty area to be monitored of a conveying system, to a system having a sound sensor and an evaluation unit connected to the sound sensor for detecting changes in an area to be monitored of a conveying system, and to a conveying system.

### BACKGROUND

Conveying systems can be, for example, elevators, escalators and moving walkways. Such conveying systems are used both for the transport of persons and for the transport of goods.

Elevators are used, inter alia, to convey passengers between different floors within a building. There are a wide variety of reasons for detecting changes in an elevator car of the elevator. In this case, the elevator car can form the area to be monitored within the meaning of the invention. Changes within the elevator car can include:
A change in the number of persons in the elevator car;
A change in the number of movable objects, such as luggage, cases, and any objects. Objects may be, for example: objects lost by a person, such as, for example, a set of keys, a mobile telephone, an envelope, tools such as a hammer, screwdriver, etc., or the like;
A handrail, mirror, seat, etc. of an elevator car interior that is no longer fixed to its intended location due to wear and tear, aging or vandalism.

In addition to detecting changes, it can also be useful or necessary to detect whether an elevator car is empty or occupied. “Occupied” is to be understood here broadly as an “elevator car that is not empty”. An elevator car is not empty:
If a person is in the elevator car, and/or
If an object, in particular a movable object, is in the elevator car.

There are a wide variety of reasons why it is necessary to detect a change in an elevator car or to know the “empty” or “occupied” state of the elevator car. In the empty state, for example, the light of the elevator car and/or the ventilation of the elevator car can be switched off. Furthermore, a specific floor may only be approached by the empty elevator car, but not if the elevator car is occupied. It is also conceivable that in the case of an elevator car having a plurality of doors, the opening of one or more doors may be possible at the same time only when the elevator car is empty. Such requirements are necessary for elevator systems that operate between different security areas, as is the case at airports, authorities or even hospitals.

An area to be monitored of an elevator system can also be the access area to the elevator system, i.e., an accessible area around a shaft door of the elevator system on a floor. The size of this area to be monitored depends on the respective requirements, but is typically an area with a radius of up to a few meters around the shaft door, for example up to 5 meters, preferably up to 3 meters and particularly preferably up to 2 meters. The shape of the area can of course also be angular, such as square.

In the case of escalators and moving walkways, the area to be monitored can be formed by the entrance area or access area to the escalator or moving walkway as well as by the exit area or output area of the escalator or moving walkway. The size of this area to be monitored in turn depends on the respective requirements.

Various systems are known from the prior art for monitoring areas.

For example, sensors are known which can detect the presence of persons in a room. These are based, for example, on ultrasound and use the Doppler effect to identify persons. However, this requires minimal movements of the persons, for example of the hands or the head. These sensors based on the Doppler effect cannot detect persons or objects that are absolutely still. Other sensors are based on infrared. These can detect persons, but are ill-suited or not at all suited for detecting objects.

Furthermore, systems for detecting changes in an elevator car are known, which are based on the evaluation of optical images, for example photos or video images. However, these systems are ill-suited to elevator cars having one or more transparent side walls or a transparent floor, since the environment outside the elevator car changes. Screens in elevator cars which show moving content and can lead to incorrect information in the case of an optical evaluation are also encountered nowadays.

Another system and method for detecting changes in a room is “UltraSense: A Self-Calibrating Ultrasound-Based Room Occupancy Sensing System”, Abbass Hammoud, Michel Deriaz, Dimitri Konstantas, Procedia Computer Science 109C (2017) 75-83. This known method is based on emitting an ultrasound pulse, recording a response signal of the ultrasound pulse and directly calculating a Fourier transform of the response signal for further evaluation of a frequency spectrum of the response signal with regard to Doppler shifts.

### SUMMARY

An object of the present invention is to provide a robust system and a robust method for detecting changes of any kind in an area to be monitored. It should also be reliably detected whether one or more stationary objects and/or persons are present or not and/or whether their number and/or position has changed.

A further object of the present invention is to provide a robust system and a robust method for detecting an empty area to be monitored and a conveying system having such a system.

Advantageous embodiments of the invention are described and/or specified in the further description of the invention.

The method according to the invention for detecting changes in an area to be monitored of a conveying system has a sound sensor and an evaluation unit connected to the sound sensor. The method is characterized by
emitting an acoustic pulse into the area to be monitored,
recording an acoustic response signal of the pulse as an actual signal,
determining an envelope of the actual signal,
detecting changes on the basis of the envelope.

This method according to the invention enables reliable detection of changes in the area to be monitored, which can be formed by an elevator car, for example. Determining the envelope ensures that the detection of changes is largely independent of the frequency of the acoustic pulse used. Furthermore, it has proven experimentally that detecting changes on the basis of the envelope functions reliably.

In comparison to the prior art, which is based on the Doppler effect for detecting changes, it is also possible with this method to detect stationary persons and objects.

Furthermore, it is advantageous that the data used, in particular the actual signal, do not permit identification of a specific person.

According to a preferred embodiment of the invention, detecting changes on the basis of the envelope is characterized by determining a spectrum of the envelope of the actual signal. This spectrum is referred to as the actual measurement.

According to a further preferred embodiment of the invention, a reference measurement is compared with the actual measurement in order to detect a change.

This advantageous embodiment allows the comparison of the actual measurement with a reference measurement, which has proven advantageous in tests.

According to a preferred embodiment of the invention, a frequency spectrum is used as the spectrum.

According to a further, preferred embodiment of the invention, an amplitude spectrum, for example an amplitude-frequency spectrum, is used as the spectrum.

This advantageous embodiment allows in particular the amplitude spectra to be compared with one another. In the case of the amplitude spectra, in comparison to other spectra of the frequency space, such as a phase spectrum, a spectrum of the real part or a spectrum of the imaginary part, it has proven to be advantageous that the amplitude spectrum is independent of a time shift of the actual signal or partial time shifts of partial signals of the actual signal. “Amplitude” refers here to the root of the sum of the squares of the real part and the imaginary part.

For example, it was determined during test measurements that despite unchanged test conditions in the area to be monitored, a certain variation in the signal, i.e., in the actual signal as well as in the reference signal, can be determined. It is believed that these variations are due to air turbulence or temperature fluctuations in the area to be monitored. Turbulence can be caused, for example, by persons entering the area to be monitored, leaving the area, crossing the area or even entering the area for only a short period of time and leaving again. However, the test measurements have shown that the amplitude spectra for different signals are largely the same under the same conditions in the area to be monitored, despite variations in the signal.

According to a preferred embodiment of the invention, a difference between the reference measurement and the actual measurement is determined during the comparison.

According to a preferred embodiment of the invention, a comparison value is determined by summing the differences or by summing values determined from the differences.

According to a preferred embodiment of the invention, the actual measurement is detected as being different from the reference measurement if the comparison value exceeds a tolerance threshold.

According to a preferred embodiment of the invention, the acoustic pulse is emitted over an angular range or an opening angle of at least 90 degrees.

This advantageous embodiment allows the area to be monitored to be determined geometrically by the angular range of the emitted pulse.

For example, an access area to or from a conveying system is typically open, i.e., not delimited from the rest of the room by structural measures. However, it may be desirable to monitor the access area. In an elevator system, it can be useful to obtain information as to whether a person, an object or even a robot is in front of a shaft door. For example, a person may trigger an elevator call, but before the elevator car can reach the floor from which the call was triggered, the person may move away from the elevator system again. In such a case, a call can be canceled by monitoring the access area as soon as there is no longer a person in the area to be monitored—the access area to the elevator system.

This advantageous embodiment also makes it possible to detect objects which are deposited in the access area or in the area to be monitored and which could endanger the safety of persons.

According to a preferred embodiment of the invention, the evaluation unit has a processor, at least one memory connected to the processor via a bus, and at least one interface for communication connected via the bus.

According to a preferred embodiment of the invention, the determinations and the detection of changes are carried out by the evaluation unit.

A further aspect of the invention relates to a method for detecting an empty area to be monitored of a conveying system, wherein the reference signal is determined for this purpose when the area to be monitored is empty.

According to a preferred embodiment of the invention, the area to be monitored is detected as being empty if the actual signal is detected as being substantially equal to the reference signal.

A further aspect of the invention relates to a system having a sound sensor and an evaluation unit connected to the sound sensor for detecting changes in an area to be monitored of a conveying system for carrying out one of the methods described above.

A further aspect of the invention relates to a conveying system having the system described above.

Embodiments of the invention will be described in the following with reference to the accompanying drawings, although neither the drawings nor the description should be construed as limiting the invention.

Further preferred embodiments of the invention are also described with reference to the exemplary embodiments.

### DESCRIPTION OF THE DRAWINGS

FIG. 1 shows purely schematically an elevator car.

FIG. 2 shows purely schematically an elevator system.

FIG. 3 shows purely schematically for a reference measurement an acoustic pulse, a response signal of the pulse and its envelope as well as an associated spectrum.

FIG. 4 shows purely schematically for an actual measurement the acoustic pulse, a response signal of the pulse and its envelope as well as an associated spectrum.

FIG. 5 shows purely schematically a section of an elevator system in which an area to be monitored is located in front of a shaft door of the elevator system.

FIG. 6 shows purely schematically a method for detecting changes in an area to be monitored.

The drawings are merely schematic, and not to scale. In the different figures, identical reference signs denote identical or similar features.

### DETAILED DESCRIPTION

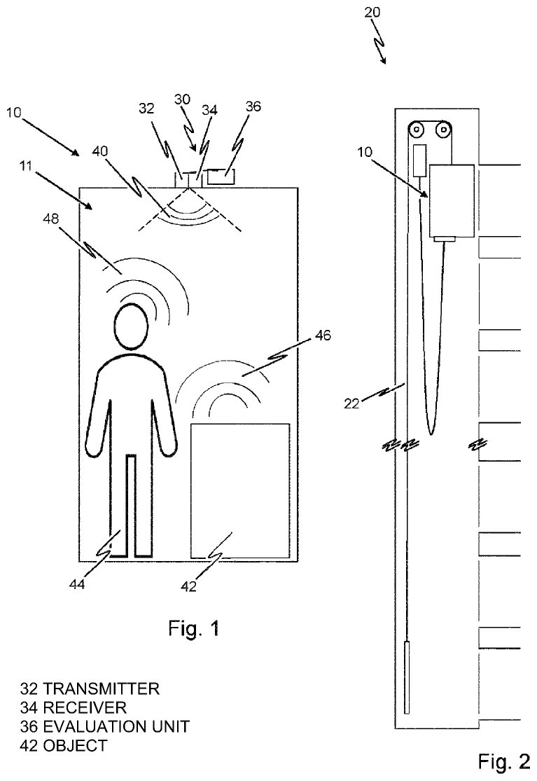

FIG. 1 shows an elevator car 10 for an elevator system 20 shown in FIG. 2, which elevator system, as described above, is a conveying system within the meaning of this patent application. As shown in FIG. 2, the elevator system 20 has the elevator car 10 which can be moved between different floors by means of a drive system. A traction sheave elevator is shown as the drive system, but any desired drive system for an elevator system can be used. Wire ropes are shown as support means 22, but support belts or the like can also be used. Alternative drive systems such as a hydraulic elevator, a rack and pinion hoist, a vacuum elevator or a cable-free elevator implemented by means of a linear motor, for example, can also be used.

As shown in FIG. 1, the elevator car 10 is equipped with a detection module 30. The detection module has a transmitter 32, a receiver 34 and an evaluation unit 36 connected to the transmitter 32 and the receiver 34. In this exemplary embodiment, an area 11 to be monitored is formed by the elevator car 10. The area is delimited by side walls, a floor surface, a ceiling surface and a car door of the elevator car 10.

The evaluation unit 36 typically has a processor, at least one memory connected to the processor via a bus and at least one interface for communication connected via the bus.

The detection module 30 serves to detect changes within the elevator car 10. A change can be an added object 42, such as a forgotten package. Furthermore, a change within the elevator car can also be a new person 44 in the elevator car 10. An object removed from the elevator car 10, such as a handrail, can also be a change. The aim of the invention is to detect any changes in the interior of the elevator car 10 or in the area 11 to be monitored.

For this purpose, the transmitter 32 emits an acoustic pulse 40, in particular a sound pulse of approximately 48 kHz and a duration of approximately 0.3 ms. The duration of 0.3 ms corresponds to some oscillations at 48 kHz, wherein it is to be observed that the transmitter 32 also has a rise time and a decay time. The frequency was selected such that it is neither audible for humans nor pets, such as dogs. If a frequency other than 48 kHz is selected, the duration must be adapted accordingly. Ultrasound is preferably used as the sound at a frequency of 16 kHz or more, so that the pulse and its response signal are not audible or only weakly audible, at least for humans.

The transmission takes place over an angular range of at least 90°, preferably of at least 120° and particularly preferably of at least 150°. The angular range is understood here to mean the opening angle over which the pulse is emitted. In the case of an angular range of 180°, the entire interior of the car can normally be detected by the pulse or sound signal 40. The angular range is shown in FIG. 1 by dashed lines. In FIG. 1, the transmitter 32 is arranged centrally on the ceiling of the elevator car 10. Alternatively, if the transmitter 32 were arranged in a corner of the elevator car 10, a pulse 40 that is emitted over an angular range of 90° would also cover the entire interior of the elevator car 10.

The pulse 40 is reflected by surfaces of the elevator car 10 as well as by any objects 42 or persons 44 and animals within the car 10. Objects can be movable objects such as packages, but also objects that are fixed in the interior of the car, such as handrails and the like. The reflected sound signal of the object 42 shown in FIG. 1 is represented by a wave packet 46. The reflected sound signal of the person 44 shown in FIG. 1 is represented by the wave packet 48.

The reflected sound signals 46, 48 are detected by the receiver 34 as an acoustic response signal of the pulse 40 and forwarded to the evaluation unit 36 for evaluation.

FIG. 1 shows both a transmitter 32 and a receiver 34. In an alternative embodiment, the function of the transmitter and the receiver can be combined in one device which can be operated both as a transmitter and as a receiver. Such a device is referred to as a transducer.

The method for detecting changes in an area to be monitored is described in detail below on the basis of an elevator car as the area to be monitored.

The method according to the invention serves to detect changes. The aim is not to detect what has changed, but rather whether a change has taken place.

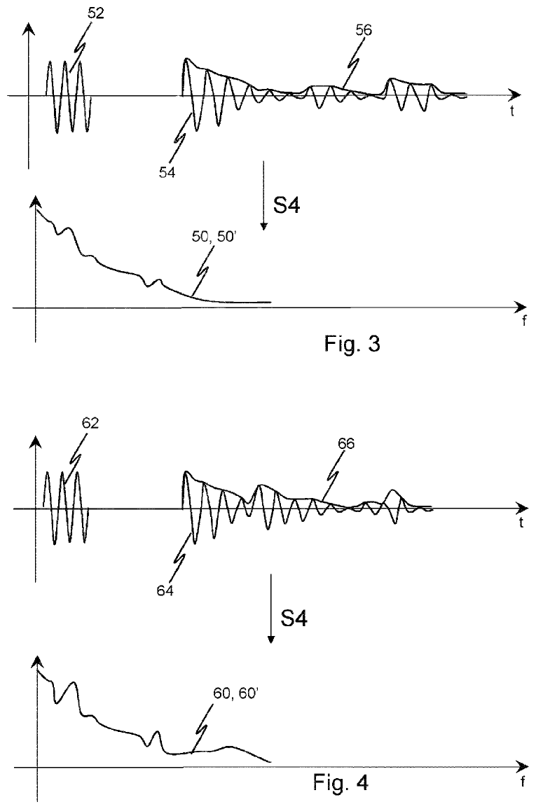

According to an exemplary embodiment of the invention, the evaluation unit 36 requires at least one reference measurement 50 shown in FIG. 3, which is recorded in that state of the elevator car in relation to which changes are to be detected. In principle, the reference measurement and the actual measurement are carried out analogously to one another, but at different points in time.

To determine the reference measurement 50, as shown in FIG. 3, an acoustic pulse 52, shown as pulse 40 in FIG. 1, is emitted as described above. The acoustic response signal of the emitted pulse is received by the receiver 34 and referred to as the reference signal 54. The frequency of the response signal substantially corresponds to that of the emitted pulse, but can also be slightly different. However, the duration and the amplitude of the response signal differ from the emitted pulse. The envelope which is referred to as the reference envelope 56 is then determined from the reference signal 54. An amplitude spectrum 50′ of the envelope is determined from the reference envelope 56 using a Fourier transform and stored as a reference measurement 50.

For example, the reference measurement 50 can be stored in the memory of the evaluation unit 36. Alternative storage locations such as storage in a data memory connected via a data communication network are also conceivable. The data memory can be local or else decentralized.

Various methods are known in acoustics for determining the envelope 56. The envelope of a signal reflects the course of the amplitude of the signal.

In the present case, the envelope 56 of the reference signal 54 reflects the amplitude profile of the reference signal 54.

In general, the envelope of a signal, for example an amplitude mode modulated signal, can be determined, for example, as follows. The demodulation or the determination of the envelope is carried out by rectifying the signal with the aid of a diode. The rectified signal is charged into a capacitor, which in turn can be discharged through a resistor. This results in the envelope of the signal. This is described, for example, in the book “Die Audio-Enzyklopädie: ein Nachschlagewerk für Tontechniker” (“The Audio Encyclopedia: A Reference Guide for Sound Engineers”), ISBN 3598117744, page 13. This can be implemented mathematically, for example, as follows. First, the absolute values are determined. Alternatively, only the positive values of the signal can be taken. The values are then averaged over a certain period of time in order to determine the envelope. The averaging can take place, for example, via summation and calculation of the mean value, in particular a sliding mean value, or by means of a corresponding integral.

As an alternative to averaging, the individual maxima of the signal can also be connected in order to obtain the envelope of the signal. The individual maxima can also be connected to one another by means of interpolation.

A Fourier transform is proposed above for determining the amplitude spectrum 50′. Instead of a Fourier transform, a fast Fourier transform, which is more suitable in terms of computation, can also be used. Other methods and/or transforms for frequency analysis or more generally for function analysis can also be used, such as a wavelet transform.

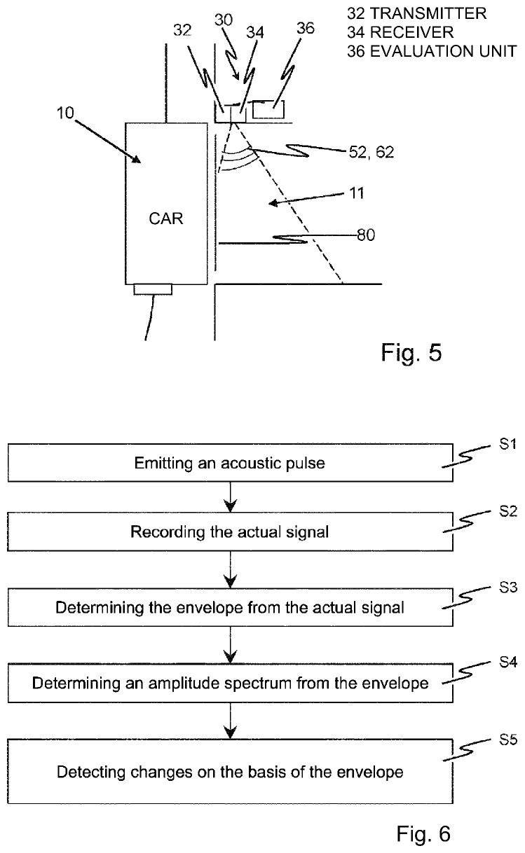

In order to be able to detect a change from the point in time of the reference measurement 50 in and/or on the elevator car 10 at any point in time after the recording of the reference measurement 50, the method according to the invention is carried out as follows. The method steps are shown purely schematically in FIG. 6.

As shown in FIG. 4, in a method step S1, an acoustic pulse 62 is emitted as described above. The pulse 62 propagates in the car 10, the interior of which forms the area 11 to be monitored, and is reflected by reflective surfaces. The acoustic response signal of this pulse 62 is shown in FIG. 1 by sound waves 46, 48.

This acoustic response signal is again received or recorded analogously to the method of reference measurement 50, in a method step S2 by the sound sensor 34, which is also referred to as the receiver. The received signal is referred to as the actual signal 64. Then, in a method step S3, the envelope of the actual signal 64, the actual envelope 66, is determined as described above.

In this exemplary embodiment, an amplitude spectrum 60′ of the envelope 66, which forms the actual measurement 60, is determined from the actual envelope 66 in a method step S4, again using a Fourier transform, as also already described above. Since the individual values of the spectrum are generally complex numbers, the amplitude is the square root of the sum of the squares of the real and imaginary parts of the complex number. The alternatives to the Fourier transform described above can also be applied analogously to the envelope of the actual signal.

As the next step, changes are detected on the basis of the envelope 66 in a method step S5.

For this purpose, the actual measurement 60 is compared with the reference measurement 50 in this exemplary embodiment.

The comparison can be determined, for example, by determining the difference between the reference measurement 50 and the actual measurement 60 as a function of the frequency. The absolute values of the differences can be summed over a frequency range in order to obtain a comparison value, also referred to as a measure, for the equality of the reference measurement 50 to the actual measurement 60. Instead of the absolute values, the squares of the differences can also be summed over the frequency range. Instead of a summation, an integration can also be carried out, of course. Other comparison operations by means of which the equality or similarity of two functions can be determined can of course also be used. For example, zero crossings can be used for this purpose.

The measure of equality obtained can be compared with a tolerance threshold in a subsequent step in order to detect a change in the elevator car 10: the interior of the elevator car is detected as being unchanged if the measure is smaller than the tolerance threshold, otherwise a change within the elevator car is detected. If the measure is less than the tolerance threshold, the actual measurement 60 is substantially equal to the reference measurement 50.

Further exemplary embodiments and embodiments are described below, wherein only differences from the exemplary embodiments already described will be discussed.

It has also been found that the measurement results appear to be different at different temperatures. It is further assumed that turbulences in the air within the elevator car 10 influence the measurements. In order nevertheless to reliably detect changes in the elevator car 10 and in an area 11 to be monitored, a plurality of reference measurements is carried out, for example over a longer period of time, for example over a time range of 24 hours, in a further exemplary embodiment and also a further embodiment of the invention.

Furthermore, reference measurements can additionally or alternatively be carried out as follows. If changes to an empty elevator car are to be detected, a plurality of reference measurements of the empty elevator car is carried out over a certain period of time after, for example, a person has left the elevator car so that reference measurements are recorded in the case of different turbulences within the elevator car.

It has also been shown that reference measurements should not only be recorded after just one person has left the elevator car, but also when multiple persons have left the elevator car. Furthermore, reference measurements can be recorded after a person has left the elevator car with a pet, such as a dog.

In the case of the plurality of reference measurements, the actual measurement is compared with each reference measurement and that reference measurement which has the smallest deviation from the actual measurement is used for further evaluation.

In an exemplary embodiment shown in FIG. 5, the transmitter 32 and the receiver 34 are arranged on a floor, outside the elevator car 10 and the shaft. The evaluation unit 36 can also be arranged on the floor or also at any other location, for example in a cladding of a shaft door 80. The emission angle as well as the emission direction of the pulse is selected such that only waves of the pulse 52, 62 for the actual measurement 60 or for the reference measurement 50 are emitted into the area 11 to be monitored in front of the shaft door 80. The area 11 in front of the shaft door can be open, i.e., not delimited by special structural measures, partition walls or the like. Of course, the area to be monitored can be marked appropriately, for example by floor markings, railings or balustrades that partially delimit the area. However, this is not absolutely necessary.

According to a further exemplary embodiment and a further embodiment, the conveying system is designed as an escalator or moving walkway. In the case of an escalator or moving walkway, for example, the access area or the output area can be monitored for changes or whether it is empty or occupied by at least one person, object or animal. For example, an operating mode of the escalator or moving walkway could be triggered on the basis of the monitoring. It would be conceivable, for example, for the escalator or moving walkway to be started as soon as a change in the access area is detected. It would also be conceivable for an escalator or moving walkway to be started only if the output area is empty at this time.

According to a further exemplary embodiment as well as a further embodiment, the area to be monitored can also be limited by the propagation time of the emitted pulses and their reflected response signals. For example, only measured values greater than a minimum duration and less than a maximum duration can be used by the actual signal. The area to be monitored can be restricted by the propagation duration.

According to a further exemplary embodiment as well as a further embodiment, a reference measurement at a specific point in time or in a predetermined state of the conveying system can be dispensed with. In this case, the conveying system is continuously monitored for changes. Instead of the reference measurement or the reference measurements used in the other exemplary embodiments, one or more actual measurements are used as reference measurements and continuously monitored for changes that occur.

According to a further exemplary embodiment as well as a further embodiment, the detection of changes on the basis of the envelope is detected by a neural network. For this purpose, for example, the neural network is trained with envelopes that were determined in that state of the area to be monitored in relation to which changes are to be detected. The method step S4 described above, in which the spectrum of the envelope is determined, can be dispensed with in this exemplary embodiment. However, it is also possible to first determine the spectrum of the envelope and to train the neural network with spectra of the space to be monitored, as well as to base the detection of changes thereon.

According to a further exemplary embodiment as well as a further embodiment, in order to detect changes on the basis of the envelope, the envelope is analyzed in order to determine a property parameter for the space to be monitored and to compare it with an associated reference parameter. For example, zero crossings can be counted in the case of an envelope that has previously been high-pass filtered as part of the analysis, in particular in the time domain. The (current) state of the monitored space can be concluded on the basis of the number. The more features or property parameters are determined from the envelope, the more precisely the space monitoring can be carried out.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A method for detecting changes in an area to be monitored of a conveying system, the conveying system having a sound sensor and an evaluation unit connected to the sound sensor, the method comprising the steps of:
emitting an acoustic pulse into the area to be monitored;
recording an acoustic response signal as an actual signal, the acoustic response signal being detected by the sound sensor as a reflection of the acoustic pulse in the area;
determining an envelope of the actual signal;
detecting changes in the area based upon the envelope; and
wherein the detecting changes is performed by determining a spectrum of the envelope of the actual signal as an actual measurement.

15. The method according to claim 14 wherein the spectrum is a frequency spectrum.

16. The method according to claim 14 wherein the spectrum is an amplitude-frequency spectrum.

17. The method according to claim 14 wherein the detecting changes is further performed by comparing a reference measurement with the actual measurement.

18. The method according to claim 17 wherein all differences between the reference measurement and the actual measurement are determined during the comparison.

19. The method according to claim 18 wherein a comparison value is determined by summing the differences or by summing values determined from the differences.

20. The method according to claim 19 wherein the actual measurement is detected as being different from the reference measurement when the comparison value exceeds a tolerance threshold.

21. The method according to claim 14 wherein the acoustic pulse is emitted over an angular range of at least 90 degrees.

22. The method according to claim 14 wherein the evaluation unit includes a processor, at least one memory connected to the processor via a bus, and at least one interface for communication connected via the bus.

23. The method according to claim 14 wherein the determining steps and the detecting changes step are performed by the evaluation unit.

24. A method for detecting an empty area to be monitored of a conveying system, the method comprising the steps of:
performing the method according to claim 14;
performing the detecting changes step by comparing a reference measurement with the actual measurement; and
determining the reference measurement when the area to be monitored is empty.

25. The method according to claim 24 wherein the area to be monitored is detected as being empty when the actual measurement is detected as being substantially equal to the reference measurement.

26. A system for monitoring an area to be monitored of a conveyor system, the system comprising:
a sound sensor;
an evaluation unit connected to the sound sensor for detecting changes in the area to be monitored; and
wherein the system is adapted to perform the method according to claim 14.

27. A conveying system having an area to be monitored and the system according to claim 26 monitoring the area to be monitored.
